(19) United States
(12) Patent Application Publication
(10) Pub. No.: US 2008/0047576 A1
(43) Pub. Date: Feb. 28, 2008

(54) SINGLE-SUBSTRATE TYPE APPARATUS FOR PROCESSING A SUBSTRATE

(75) Inventors: Young-Ok KIM, Gyeonggi-do (KR); Chang-Ki HONG, Gyeonggi-do (KR); Kun-Tack LEE, Gyeonggi-do (KR); In-Gi KIM, Gyeonggi-do (KR); Woo-Gwan SHIM, Gyeonggi-do (KR); Jeong-Nam HAN, Seoul (KR); Kang-Youn LEE, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/844,241

(22) Filed: Aug. 23, 2007

(30) Foreign Application Priority Data
Aug. 23, 2006 (KR) 2006-79998

(51) Int. Cl. B08B 3/12; B08B 3/10

(52) U.S. Cl. 134/1; 134/114; 134/133; 134/135

(57) ABSTRACT

In a single-substrate type apparatus for processing a substrate, the apparatus includes a chamber, a bottom panel, a solution supplying part and a substrate holder. The chamber has an upper portion and a lower portion. The bottom panel is detachably connected to the lower portion. The solution supplying part is connected to the bottom panel to supply a processing solution to the substrate in the chamber. The substrate holder provides the substrate into the chamber, the substrate holder holding both side portions of the substrate such that the substrate is vertically arranged.

### CROSS-REFERENCE TO RELATED APPLICATIONS

This application claims priority under 35 U.S.C. § 119 to Korean Patent Application No. 2006-79998, filed on Aug. 23, 2006 in the Korean Intellectual Property Office (KIPO), the disclosure of which is incorporated herein by reference in its entirety.

### BACKGROUND

1. Technical Field

The present invention relates to a single-substrate type apparatus and method for processing a substrate. Specifically, the present invention relates to a single-substrate type apparatus and method for processing a substrate employed to sequentially perform a cleaning process and a drying process on a single substrate.

2. Description of the Related Art

In general, semiconductor devices are manufactured through a fabricating process for forming an electrical circuit on a substrate, such as a silicon wafer, an electrical die sorting (EDS) process for testing electrical characteristics of the semiconductor device after the fabricating process, and a package process for packaging the semiconductor devices using an epoxy resin after separating the wafer into individual chips.

The fabricating process includes a depositing process for forming a layer on a wafer, a chemical mechanical polishing (CMP) process for planarizing a surface of the layer, a photolithography process for forming a photoresist pattern on the layer, an etching process for forming a pattern having electrical characteristics in the surface of the layer using the photoresist pattern as a mask pattern, an implantation process for implanting ions into designated areas of the wafer, a cleaning process for removing particles from the wafer, a drying process for drying the wafer after the cleaning process and a testing process for detecting defects of the layer or the pattern.

Typically, the cleaning process and the drying process are sequentially performed. An apparatus for processing a substrate used to sequentially perform the cleaning process and the drying process is widely used. For example, a batch-type apparatus for processing a substrate may be used to sequentially perform a cleaning process for cleaning a plurality of substrates using cleaning solutions, a rinsing process for rinsing the cleaned substrates using rinsing solutions and a drying process for drying the rinsed substrates.

For example, a conventional cleaning and drying apparatus is disclosed in U.S. Pat. No. 6,068,002 issued to Kamikawa, et al. The conventional cleaning and drying apparatus includes a cleaning container, a drying container, a shutter and a wafer boat. A cleaning solution or a rinsing solution is stored in the cleaning container. The drying container is located over the cleaning container. The shutter is located between the cleaning container and the drying container. The wafer boat may be used to transfer wafers between the cleaning container and the drying container.

When a cleaning process and a drying process are performed on a substrate using the conventional batch-type apparatus for processing the substrate, recontamination of the substrate may occur while the cleaning process is performed on the substrate. As an integration degree of a semiconductor device increases, the recontamination of the substrate becomes a critical issue. For example, the recontamination of the substrate may reduce the productivity and reliability of the semiconductor device in processes for manufacturing the semiconductor device including a metal gate and a dielectric layer that includes a material having a relatively high dielectric constant.

In addition, when the drying process is performed using the conventional batch-type apparatus, a drying gas such as isopropyl alcohol vapor or heated nitrogen gas may not be uniformly provided onto the substrate. Thus, water spots may be formed on the substrate. The water spots formed in the drying process may reduce the productivity and reliability of the semiconductor device.

Further, a conventional single-substrate type apparatus for processing a substrate may include a rotating chuck, a solution supplying part and a gas supplying part. The rotating chuck may rotate a substrate. The solution supplying part may supply a cleaning solution and a rinsing solution onto the substrate. The gas supplying part may supply a drying gas onto the substrate processed by the cleaning solution and the rinsing solution to dry the substrate.

However, the conventional single-substrate type apparatus may clean and dry the substrate by using centrifugal force. Thus, a fine pattern formed on the substrate may be damaged by the centrifugal force. Embodiments of the present invention address these and other disadvantages of the conventional art.

### SUMMARY

Some embodiments of the present invention provide a single-substrate type apparatus for processing a substrate capable of reducing recontamination of the substrate and damage to a fine pattern formed on the substrate.

In accordance with some embodiments of the present invention, a single-substrate type apparatus for processing a substrate includes a chamber, a bottom panel, a solution supplying part and a substrate holder. The chamber has an open upper portion and an open lower portion. The bottom panel is detachably combined with the open lower portion. The solution supplying part is connected to the bottom panel to supply a processing solution to the substrate in the chamber. The substrate holder provides the substrate into the chamber. The substrate holder holds both side portions of the substrate such that the substrate is vertically arranged.

According to some embodiments of the present invention, a cleaning process and a drying process are sequentially performed by using a single-substrate type apparatus for processing a substrate. Thus, recontamination of the substrate may be effectively prevented, compared with a case where a conventional batch-type apparatus for processing a substrate is used. In addition, damage to a fine pattern may be effectively reduced, compared with a case where a conventional single-substrate type apparatus for processing a substrate employing centrifugal force is used.

### BRIEF DESCRIPTION OF THE DRAWINGS

The above and other advantages of the present invention will become readily apparent by reference to the following detailed description when considered in conjunction with the accompanying drawings in which:

FIGS. 1 and 2 are cross-sectional views illustrating a single-substrate type apparatus for processing a substrate;

FIG. 3 is a side view illustrating the single-substrate type apparatus of FIG. 1;

FIG. 4 is a schematic view illustrating the drying gas supplying part of FIG. 1; and

FIG. 5 is a schematic view illustrating a second drying gas supplying part in accordance with an embodiment of the present invention.

### DETAILED DESCRIPTION

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “on,” “connected to” and/or “coupled to” another element or layer, the element or layer may be directly on, connected and/or coupled to the other element or layer, or intervening elements or layers may be present. In contrast, when an element is referred to as being “directly on,” “directly connected to” and/or “directly coupled to” another element or layer, no intervening elements or layers are present.

It will also be understood that, although the terms “first,” “second,” etc., may be used herein to describe various elements, components, regions, layers and/or sections, these elements, components, regions, layers and/or sections should not be limited by these terms. Rather, these terms are used merely as a convenience to distinguish one element, component, region, layer and/or section from another element, component, region, layer and/or section. For example, a first element, component, region, layer and/or section could be termed a second element, component, region, layer and/or section without departing from the teachings of the present invention.

Spatially relative terms, such as “beneath,” “below,” “lower,” “above,” “upper” and the like, may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, when the device in the figures is turned over, elements described as below and/or beneath other elements or features would then be oriented above the other elements or features. The device may be otherwise oriented (rotated 90 degrees or at other orientations) and the spatially relative descriptors used herein interpreted accordingly.

The terminology used herein is for the purpose of describing particular embodiments only and is not intended to limit the invention. As used herein, the singular terms “a,” “an” and “the” are intended to include the plural forms as well, unless the context clearly indicates otherwise. It will be further understood that the terms “includes” and “including” specify the presence of stated features, integers, steps, operations, elements, and/or components, but do not preclude the presence and/or addition of one or more other features, integers, steps, operations, elements, components, and/or groups thereof.

Embodiments of the present invention may be described with reference to cross-sectional illustrations, which are schematic illustrations of idealized embodiments of the present invention. As such, variations from the shapes of the illustrations, as a result, for example, of manufacturing techniques and/or tolerances, are to be expected. Thus, embodiments of the present invention should not be construed as limited to the particular shapes of regions illustrated herein, but are to include deviations in shapes that result from, e.g., manufacturing. For example, a region illustrated as a rectangle may have rounded or curved features. Thus, the regions illustrated in the figures are schematic in nature and are not intended to limit the scope of the present invention. Like reference numerals refer to like elements throughout.

Unless otherwise defined, all terms (including technical and scientific terms) used herein may have the same meaning as what is commonly understood by one of ordinary skill in the art. It will be further understood that terms, such as those defined in commonly used dictionaries, should be interpreted as having a meaning that is consistent with their meaning in the context of this specification and the relevant art and will not be interpreted in an idealized and/or overly formal sense unless expressly so defined herein.

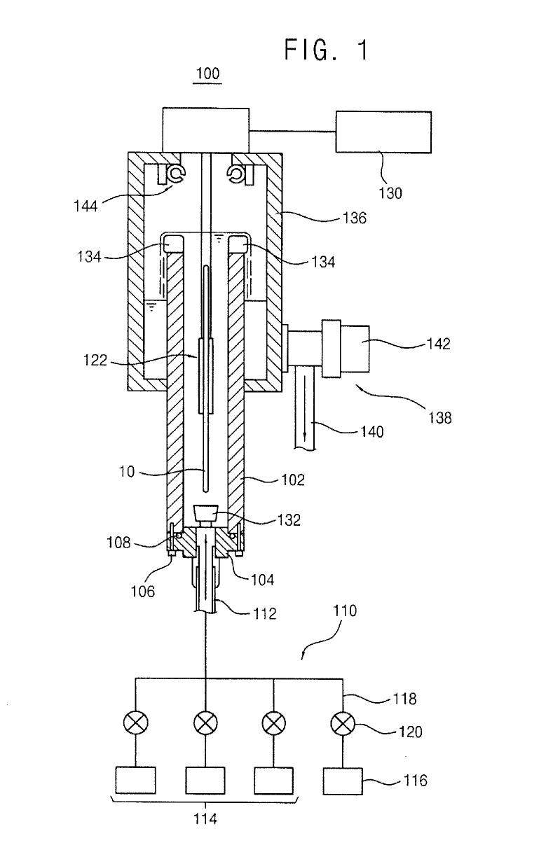

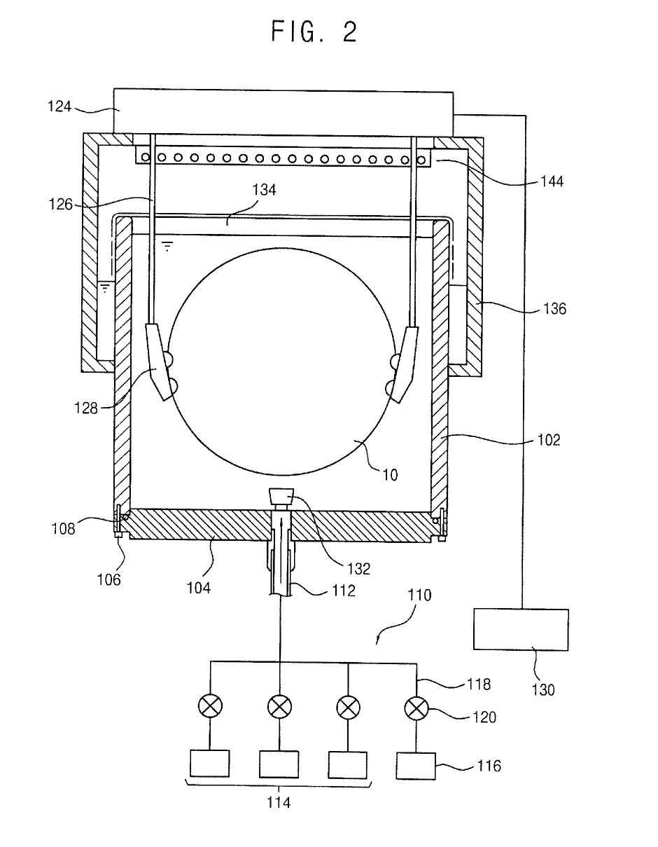

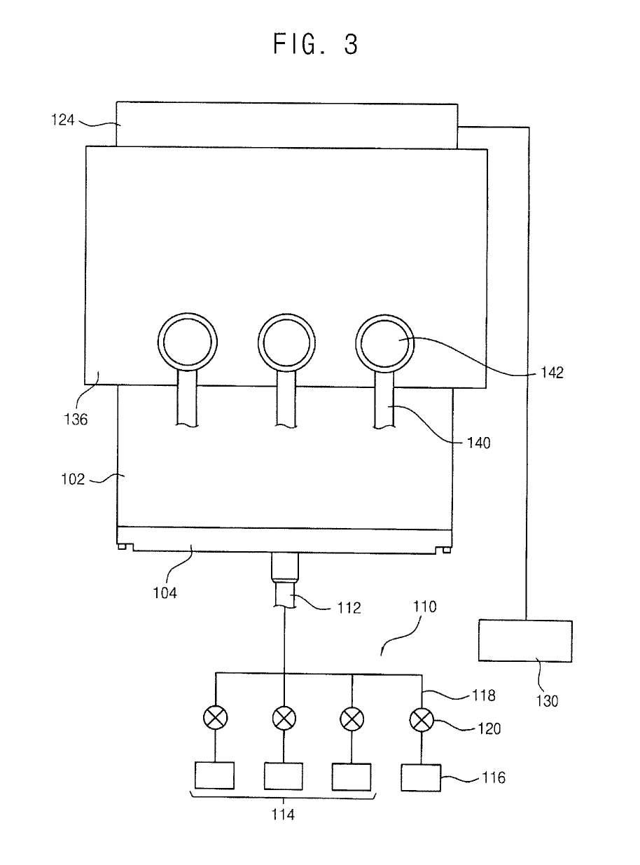

FIGS. 1 and 2 are cross-sectional views illustrating a single-substrate type apparatus for processing a substrate. FIG. 3 is a side view illustrating the single-substrate type apparatus in FIG. 1.

The single-substrate type apparatus of the present invention may be used to sequentially perform a cleaning process, a rinsing process and a drying process on a substrate, such as a wafer where a fine pattern is formed. Particularly, the single-substrate type apparatus of the present invention may be used to sequentially perform the cleaning process, the rinsing process and the drying process on a substrate where a gate structure including a gate insulation layer and a metal gate electrode are formed. Here, the gate insulation layer may be formed using a material having a dielectric constant substantially higher than that of silicon nitride.

Referring to FIGS. 1 to 3, a single-substrate type apparatus 100 includes a chamber 102 having an open upper portion and an open lower portion. One substrate 10 may be provided into the chamber 102. The chamber 102 may have a substantially rectangular cross-section. The substrate 10 may be vertically arranged in the chamber 102. Thus, the chamber 102 may have a relatively narrow width Particularly the chamber 102 may include a pair of first sidewalls spaced apart from each other by a first width and a pair of second sidewalls spaced apart from each other by a second width. As illustrated in the drawings, the chamber 102 is formed as one body. Alternatively, the first sidewalls may be combined with the second sidewalls by combining members.

The open lower portion of the chamber 102 may be closed by a bottom panel 104. The bottom panel 104 may be detachably combined with the open lower portion of the chamber 102. Particularly, the bottom panel 104 may be combined with the open lower portion of the chamber 102 by combining members 106. For example, the bottom panel 104 may be combined with the open lower portion of the chamber 102 using bolts.

A solution supplying part 110 for providing the substrate 10 in the chamber 102 with a processing solution is connected to the bottom panel 104. The solution supplying part 110 may be connected to the bottom panel 104 by a solution supplying pipe 112 so that a cleaning solution for cleaning the substrate 10 and a rinsing solution for rinsing the substrate 10 may be supplied to the substrate 10. In addition, an etching solution for removing an undesired layer such as a native oxide layer may be provided inside the chamber 102.

The solution supplying part 110 may include a plurality of cleaning solution supplying parts 114 for supplying different cleaning solutions and a rinsing solution supplying part 116 for supplying the rinsing solution. The cleaning solution supplying parts 114 and the rinsing solution supplying parts 116 may be connected to the solution supplying pipe 112 through a plurality of sub-pipes 118 and a plurality of valves 120.

For example, the cleaning solutions may be a mixture of hydrogen fluoride (HF) and water, a mixture of ammonium hydroxide (NH₄OH), hydrogen peroxide (H₂O₂) and water, a mixture of ammonium fluoride (NH₄F), hydrogen fluoride (HF) and water, a mixture of phosphoric acid (H₃PO₄) and water, a mixture of sulfuric acid (H₂SO₄) and water, etc.

A diluted hydrogen fluoride (DHF) solution formed by mixing hydrogen fluoride and deionized water is used to remove a native oxide (SiO₂) layer and metal ions. Here, a ratio of hydrogen fluoride to deionized water in the DHF solution may be about 1:500 to about 1:100. However, the ratio may vary in accordance with conditions of the cleaning process.

A mixture of ammonium fluoride, hydrogen fluoride and water generally referred to as a standard clean 1 (SC1) solution may be used to remove silicon oxide or organic material adhered to the substrate 10. A ratio of ammonium fluoride, hydrogen fluoride and water in the SC1 solution may be about 1:4:20 to about 1:4:100. However, the ratio may vary in accordance with conditions of the cleaning process.

A mixture of ammonium fluoride, hydrogen fluoride and water generally referred to as a Limulus Amebocyte Lysate (LAL) solution may be used to remove silicon oxide formed on the substrate 10.

The mixture of phosphoric acid and water and the mixture of sulfuric acid and water may be used to remove silicon oxide and silicon nitride. Particularly, the mixture of sulfuric acid and water may be used to selectively remove silicon nitride.

The rinsing solution may be deionized water.

A sealing member 108 may be provided between the chamber 102 and the bottom panel to prevent leakage of the processing solution. For example, an o-ring may be provided between the chamber 102 and the bottom panel 104.

The substrate 10 may be provided into the chamber 102 by a substrate holder 122. The substrate holder 122 may grasp both side portions of the substrate 10 such that the substrate 10 is vertically arranged. The substrate holder 122 may contact side portions of the substrate 10 that are substantially opposite of each other. The substrate holder 122 may transfer the substrate 10 into the chamber 102 to clean the substrate 10. In addition, the substrate holder 122 may transfer the substrate 10 from the inside of the chamber 102 to the outside of the chamber 102 after processes are performed on the substrate 10 in the chamber 102.

The substrate holder 122 may include a holder base 124, a pair of rods 126 and supporters 128. The rods 126 may extend downward from the holder base 124. The supporters 128 are provided at end portions of the rods 126 to support the substrate 10. However, the structure and components of the substrate holder 122 may be variously changed to accommodate specific applications. Thus, the present invention should not be construed as limited to the structure of the substrate holder 122.

The substrate holder 122 may be functionally connected to a driving part 130 providing a driving force. The driving part 130 may be configured to allow the substrate holder 122 to move vertically. Thus, the substrate holder 122 may shift the substrate 10 between the inside of the chamber 102 and the outside of the chamber 102. For example, a conventional Cartesian coordinates robot may be used as the driving part 130.

A first ultrasonic wave generator 132 for applying ultrasonic wave energy to the processing solution in the chamber 102 may be provided on the bottom panel 104. The first ultrasonic wave generator 132 may have a bar shape that extends horizontally. The bottom panel 104 may have a central hole for providing the processing solution. The first ultrasonic wave generator 132 may be spaced apart from an upper face of the bottom panel 104 to efficiently provide the processing solution.

In addition, second ultrasonic wave generators 134 may be arranged on an upper portion of the chamber 102 such that the second ultrasonic wave generators 134 are adjacent to a surface of the processing solution provided into the chamber 102. Particularly, a pair of second ultrasonic wave generators 134 may be respectively provided adjacent to a front face and a rear face of the substrate 10 such that the pair of second ultrasonic wave generators 134 may face each other. The second ultrasonic wave generators 134 may be arranged in parallel with the first ultrasonic wave generator 132. The first and second ultrasonic wave generators 132 and 134 may be wave generators that are configured to provide wave energy other than ultrasonic wave energy, for example, simply agitation.

As described above, the single-substrate type apparatus 100 includes the bottom panel 104 detachably combined with the chamber 102. Thus, a process for removing impurities from inner faces of the chamber 102 or the bottom panel 104 may be effectively performed periodically or when required. In addition, a time required for performing the above process may be shortened. Elements arranged in the chamber 102 such as the first ultrasonic wave generator or the second ultrasonic wave generators may be efficiently moved or replaced. In addition, a time required for moving or replacing the elements may be shortened.

Referring again to FIGS. 1 to 3, an outer chamber 136 for storing an overflowed processing solution from the chamber 102 may be provided on outer faces of the chamber 102 such that the outer chamber 136 partially encloses the chamber 102.

The processing solution may be continuously provided to the inside of the chamber 102 while the cleaning process or the rinsing process is performed on the substrate 10. The process solution may overflow the chamber 102. The overflowed process solution is temporarily stored in the outer chamber 136. The overflowed process solution stored in the outer chamber 136 may be discharged by a solution discharging part 138 connected to the outer chamber 136. The solution discharging part 138 may include discharging pipes 140 for discharging the cleaning solutions and the rinsing solution, and valves 142 for opening and closing the discharging pipes 140.

As illustrated in the drawings, the outer chamber 136 may enclose the chamber 102. Alternatively, a pair of outer chambers may be provided on the second sidewalls of the chamber 102. When the pair of outer chambers is provided on the second sidewalls of the chamber 102, holes for connecting the outer chambers are formed through the first sidewalls of the chamber 102.

Referring again to FIGS. 1 to 3, the single-substrate type apparatus 100 may further include a drying gas supplying part 144 supplying a drying gas toward a surface of the substrate 10 to dry the substrate 10 after the rinsing process is performed on the substrate 10 using the rinsing solution.

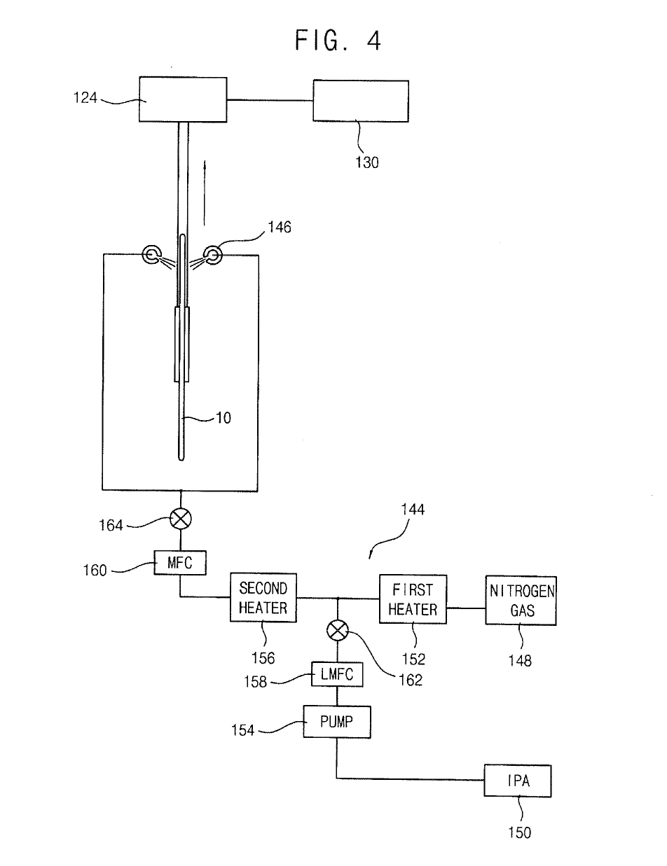

FIG. 4 is a schematic view illustrating the drying gas supplying part of FIG. 1.

Referring to FIG. 4, the drying gas supplying part 144 may supply the drying gas to the surface of the substrate 10 while the substrate 10, rinsed by the rinsing process, is upwardly shifted by the driving part 130. The drying gas may include isopropyl alcohol vapor and heated nitrogen gas.

The isopropyl alcohol (IPA) vapor may be dissolved in the rinsing solution, e.g., deionized water, residing on the substrate 10. Thus, the surface tension of the rinsing solution on the substrate 10 may be reduced so that the rinsing solution may be removed from the substrate 10. In addition, the heated nitrogen gas may be provided to sufficiently dry the substrate 10 from which the rinsing solution is removed.

The drying gas supplying part 144 may include a pair of nozzle pipes 146 providing the drying gas to the surface of the substrate 10.

The nozzle pipes 146 may be arranged in parallel with the second ultrasonic wave generators 134. Each of the nozzle pipes 146 may include a plurality of nozzles for providing the drying gas.

The drying gas supplying part 144 may include a first storage container 148, a second storage container 150, a first heater 152, a pump 154 and a second heater 156. The nitrogen gas is stored in the first storage container 148. The liquid isopropyl alcohol is stored in the second storage container 150. The first heater 152 may heat the nitrogen gas. The pump 154 may pump the liquid isopropyl alcohol. The second heater 156 may heat the drying gas.

The first heater 152 is connected to the first storage container 148. The pump 154 is connected to the second storage container 150. The second heater 156 is connected to the first heater 152 and the pump 154. The nozzle pipes 146 are connected to the second heater 156. The liquid isopropyl alcohol provided by the pump 154 is vaporized by the nitrogen gas heated by the first heater 152. The liquid isopropyl alcohol may be vaporized in a pipe between the second heater 156 and the pump 154. The second heater 156 may heat the drying gas including the isopropyl alcohol and the nitrogen gas. The drying gas is then provided to the substrate 10 by the nozzle pipes 146.

In addition, a liquid mass flow controller (LMFC) 158 is provided between the first pump 154 and the second heater 156 to control the flow rate of the liquid isopropyl alcohol. A mass flow controller (MFC) 160 is provided between the second heater 156 and the nozzle pipes 146 to control the flow rate of the drying gas.

Further, as illustrated in the drawings, a first valve 162 is provided between the LMFC 158 and the second heater 156. A second valve 164 is provided between the nozzle pipes 146 and the MFC 160.

As described above, the isopropyl alcohol vapor and the heated nitrogen gas are provided to the surface of the semiconductor substrate 10. The isopropyl alcohol may be provided to the surface of the substrate 10 as an aerosol mist by a carrier gas.

In an embodiment, a second drying gas may be additionally provided to sufficiently dry the substrate 10. Particularly, a second drying gas may be provided to the substrate 10 dried by the drying gas. The second drying gas may be heated nitrogen gas.

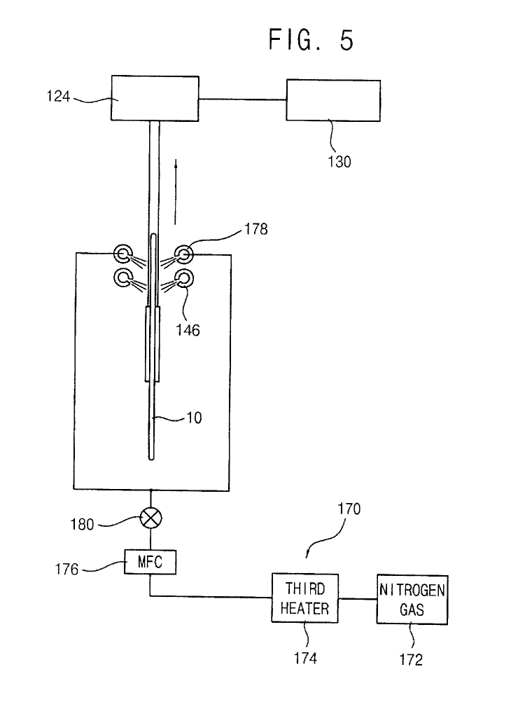

FIG. 5 is a schematic view illustrating a second drying gas supplying part in accordance with an embodiment of the present invention.

Referring to FIG. 5, the second drying gas supplying part 170 may provide the second drying gas to the initially dried surface of the substrate 10 to sufficiently dry the substrate 10 while the substrate 10 is upwardly shifted by the driving part 130.

The drying gas supplying part 170 may include a third storage container 172, a third heater 174, a second MFC 176, a pair of second nozzle pipes 178 and a third valve 180. The second drying gas may be stored in the third storage container 172. The third heater 174 may heat the second drying gas. The second MFC 176 may control the flow rate of the heated second drying gas. The pair of second nozzle pipes 178 provides the substrate 10 with the heated second drying gas. The third valve 180 is provided between the second nozzle pipes 178 and the second MFC 176.

The second nozzle pipes 178 may extend over the nozzle pipes 146 such that the second nozzle pipes 178 are substantially in parallel with the nozzle pipes 146. The second nozzle pipes 178 may have a plurality of second nozzles for providing the second drying gas.

The drying gas supplying part 144 and the second drying gas supplying part 170 may have the above configurations. However, the present invention should not be construed as limited to the described configurations of the drying gas supplying part 144 and the second drying gas supplying part 170.

According to the present invention, a cleaning process and a drying process are sequentially performed by using a single-substrate type apparatus for processing the substrate. Thus, recontamination of the substrate may be effectively prevented, compared with a case where a conventional batch-type apparatus for processing a substrate is used. In addition, damage to a fine pattern may be effectively reduced, compared with a case where a conventional single-substrate type apparatus for processing a substrate employing centrifugal force is used.

As described above, when the single-substrate type apparatus of the present invention is employed, the recontamination of the substrate may be reduced. Thus, the single-substrate type apparatus of the present invention may be used to perform a cleaning process, a rinsing process and a drying process on the substrate where a dielectric layer including a material having a relatively high dielectric constant and a metal pattern are formed. In addition, when the single-substrate type apparatus of the present invention is employed, damage to a fine pattern may be reduced. Thus, the single-substrate type apparatus of the present invention may be used to perform a cleaning process, a rinsing process and a drying process on a substrate where a fine pattern is formed.

In addition, a drying gas of the present invention may be uniformly supplied to a surface of a substrate to dry the substrate. Thus, water spots may not be formed on the substrate.

Further, the single-substrate type apparatus of the present invention may have an open end. The open end may be covered with a detachable bottom panel. Thus, a process for maintaining the single-substrate type apparatus of the present invention may be effectively performed periodically or when required. In addition, a time for performing the above process may be reduced.

In accordance with some embodiments of the present invention, an apparatus for processing a substrate includes a chamber, a bottom panel, a solution supplying part and a substrate holder. The chamber has an upper portion and a lower portion. The bottom panel is detachably connected to the lower portion. The solution supplying part is connected to the bottom panel and configured to supply a processing solution to the substrate in the chamber. The substrate holder contacts side portions of the substrate such that the substrate is disposed vertically in the chamber.

In some embodiments, the bottom panel may be connected to the lower portion of the chamber by a plurality of combining members. A sealing member may be further disposed between the chamber and the bottom panel.

According to some embodiments, a wave generator may be further disposed on the bottom panel and configured to apply energy to the processing solution in the chamber. In addition, wave generators may be further disposed at an upper portion of the chamber such that the wave generators are adjacent to a surface of the processing solution in the chamber. The wave generators may apply ultrasonic wave energy to the processing solution.

In some embodiments, the apparatus may further include an outer chamber disposed on outer faces of the chamber such that the outer chamber partially encloses the chamber. The outer chamber may contain an overflowed processing solution from the chamber. In addition, the apparatus may further include a solution discharging part connected to the outer chamber to discharge the overflowed processing solution contained in the outer chamber.

In some embodiments, the solution supplying part may include a first solution supplying part and a second solution supplying part. The first solution supplying part supplies a cleaning solution to remove impurities on the substrate. The second solution supplying part supplies a rinsing solution to rinse the substrate cleaned by the cleaning solution. The first solution providing part may include cleaning solution supplying parts supplying different cleaning solutions.

In some embodiments, the apparatus may further include a driving part configured to vertically shift the substrate holder to transfer the substrate held by the substrate holder into the chamber and transfer the substrate processed by the processing solution to the outside of the chamber. The apparatus may further include a drying gas supplying part supplying a drying gas onto a surface of the substrate rinsed by the rinsing solution to dry the substrate while the rinsed substrate is vertically shifted by the driving part. The drying gas may include isopropyl alcohol vapor and heated nitrogen gas.

According to some embodiments, a method for processing a substrate includes: providing a substrate into a chamber, the chamber comprising an upper portion, a lower portion and a bottom panel detachably connected to the lower portion; supplying processing solutions to the chamber, the processing solutions comprising one or more cleaning solutions and one or more rinsing solutions; applying wave energy to one or more of the processing solutions at the lower portion of the chamber and at the upper portion of the chamber; and supplying one or more drying gasses to the substrate while removing the substrate from the chamber. Providing the substrate may comprise suspending the substrate vertically in the chamber.

According to other embodiments, the method may further comprise overflowing one or more of the processing solutions into an outer chamber, the outer chamber at least partially enclosing the chamber. The method may also include discharging the overflowed processing solutions in the outer chamber.

According to still other embodiments, supplying the processing solutions may comprise: supplying a cleaning solution to remove impurities on the substrate; and supplying a rinsing solution to rinse the substrate. Supplying a cleaning solution may comprise supplying one or more different cleaning solutions.

According to some embodiments, supplying one or more drying gasses may comprise supplying one or more of isopropyl alcohol vapor and heated nitrogen gas.

According to some embodiments of the present invention, a cleaning process and a drying process are sequentially performed by using a single-substrate type apparatus for processing a substrate. Thus, recontamination of the substrate may be effectively prevented, compared with a case where a conventional batch-type apparatus for processing a substrate is used. In addition, damage to a fine pattern may be effectively reduced, compared with a case where a conventional single-substrate type apparatus for processing a substrate employing centrifugal force is used.

The foregoing is illustrative of the present invention and is not to be construed as limiting thereof. Although a few embodiments of this invention have been described, those skilled in the art will readily appreciate that many modifications are possible in the embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. An apparatus for processing a substrate, the apparatus comprising:
a chamber having an open upper portion and an open lower portion;
a bottom panel detachably connected to the open lower portion;
a solution supplying part connected to the bottom panel and configured to supply a processing solution to the substrate in the chamber; and
a substrate holder contacting side portions of the substrate such that the substrate is disposed vertically in the chamber.

2. The apparatus of claim 1, wherein the bottom panel is connected to the lower portion of the chamber by a plurality of combining members.

3. The apparatus of claim 1, further comprising a sealing member disposed between the chamber and the bottom panel.

4. The apparatus of claim 1, further comprising a wave generator disposed on the bottom panel and configured to apply energy to the processing solution disposed in the chamber.

5. The apparatus of claim 1, further comprising wave generators disposed at the upper portion of the chamber such that the wave generators are adjacent to a surface of the processing solution disposed in the chamber, wherein the wave generators are configured to apply wave energy to the processing solution.

6. The apparatus of claim 1, further comprising an outer chamber disposed on outer faces of the chamber such that the outer chamber at least partially encloses the chamber, the outer chamber containing an overflowed processing solution from the chamber.

7. The apparatus of claim 6, further comprising a solution discharging part connected to the outer chamber to discharge the overflowed processing solution contained in the outer chamber.

8. The apparatus of claim 1, wherein the solution supplying part comprises:
a first solution providing part configured to supply a cleaning solution to remove impurities on the substrate; and
a second solution providing part configured to supply a rinsing solution to rinse the substrate cleaned by the cleaning solution.

9. The apparatus of claim 8, wherein the first solution providing part includes cleaning solution supplying parts supplying two or more different cleaning solutions.

10. The apparatus of claim 9, further comprising an outer chamber disposed on outer faces of the chamber and at least partially enclosing the chamber, the outer chamber containing overflowed cleaning solutions and overflowed rinsing solutions from the chamber; and
a plurality of discharging parts connected to the outer chamber and configured to discharge the overflowed cleaning solutions and the overflowed rinsing solutions contained in the outer chamber.

11. The apparatus of claim 8, further comprising a driving part configured to vertically shift the substrate holder so as to transfer the substrate held by the substrate holder into and out of the chamber.

12. The apparatus of claim 11, further comprising a drying gas supplying part configured to supply a drying gas onto a surface of the substrate so as to dry the substrate while the substrate is vertically shifted by the driving part.

13. The apparatus of claim 12, wherein the drying gas includes one or more of isopropyl alcohol vapor and heated nitrogen gas.

14. The apparatus of claim 12, further comprising a second drying gas supplying part configured to supply a second drying gas to the substrate initially dried by the drying gas.

15. The apparatus of claim 14, wherein the second drying gas is heated nitrogen gas.

16. The apparatus of claim 1, wherein the substrate holder contacts the side portions of the substrate that are substantially opposite of each other.

17. A method for processing a substrate, the method comprising:
providing a substrate into a chamber, the chamber comprising an open upper portion, an open lower portion and a bottom panel detachably connected to the open lower portion;
supplying processing solutions to the chamber, the processing solutions comprising one or more cleaning solutions and one or more rinsing solutions;
applying wave energy to one or more of the processing solutions at the open lower portion of the chamber;
applying wave energy to one or more of the processing solutions at the open upper portion of the chamber; and
supplying one or more drying gasses to the substrate while removing the substrate from the chamber.

18. The method of claim 17, wherein providing the substrate comprises suspending the substrate vertically in the chamber.

19. The method of claim 17, further comprising overflowing one or more of the processing solutions into an outer chamber, the outer chamber at least partially enclosing the chamber.

20. The method of claim 19, further comprising discharging the overflowed processing solutions in the outer chamber.

21. The method of claim 17, wherein supplying the processing solutions comprises:
supplying a cleaning solution to remove impurities on the substrate; and
supplying a rinsing solution to rinse the substrate.

22. The method of claim 21, wherein supplying a cleaning solution comprises supplying one or more different cleaning solutions.

23. The method of claim 17, wherein supplying one or more drying gasses comprises supplying one or more of isopropyl alcohol vapor and heated nitrogen gas.

24. An apparatus for processing a substrate, the apparatus comprising:
a chamber having an open upper portion and an open lower portion;
a bottom panel detachably connected to the open lower portion;
a sealing member disposed between the chamber and the bottom panel;
a solution supplying part connected to the bottom panel and configured to supply a processing solution to the substrate in the chamber;
a first ultrasonic wave generator disposed on the bottom panel and configured to apply energy to the processing solution disposed in the chamber;
second ultrasonic wave generators disposed at the upper portion of the chamber such that the wave generators are adjacent to a surface of the processing solution disposed in the chamber;
a substrate holder, the substrate holder contacting both side portions of the substrate such that the substrate is disposed vertically in the chamber;
an outer chamber disposed on outer faces of the chamber such that the outer chamber at least partially encloses the chamber, the outer chamber containing an overflowed processing solution from the chamber;
a solution discharging part connected to the outer chamber to discharge the overflowed processing solution contained in the outer chamber;
a driving part configured to vertically shift the substrate holder so as to transfer the substrate held by the substrate holder into and out of the chamber; and
a drying gas supplying part configured to supply a drying gas onto a surface of the substrate so as to dry the substrate while the substrate is vertically shifted by the driving part.

25. The apparatus of claim 24, wherein the solution supplying part comprises:
a first solution providing part configured to supply a cleaning solution to remove impurities on the substrate; and
a second solution providing part configured to supply a rinsing solution to rinse the substrate cleaned by the cleaning solution, wherein the first solution providing part includes cleaning solution supplying parts configured to supply two or more different cleaning solutions.
